(19) United States
(12) Patent Application Publication
(10) Pub. No.: US 2009/0278475 A1
(43) Pub. Date: Nov. 12, 2009

(54) HEARTBEAT EMULATING LIGHTED DEVICE

(76) Inventor: Michael Clow, Chandler, AZ (US)

Correspondence Address: BOOTH UDALL, PLC, 1155 W. Rio Salado Pkwy., Suite 101, Tempe, AZ, 85281, US

(21) Appl. No.: 12/463,276

(22) Filed: May 8, 2009

Related U.S. Application Data
(60) Provisional application No. 61/051,404, filed on May 8, 2008.

(51) Int. Cl. H05B 37/02

(52) U.S. Cl. 315/294

(57) ABSTRACT

A heartbeat emulating lighted device includes a base layer having an upper surface and a lower surface. A control circuit and light source are coupled with the base layer, and the control circuit and light source are capable of illuminating the base layer and outputting a first light pulse output and a second light pulse output, such that a systole and a diastole of a human heartbeat is visually represented.

### CROSS REFERENCE TO RELATED APPLICATIONS

This document claims the benefit of the filing date of U.S. Provisional Patent Application 61/051,404 to Clow entitled “Heartbeat Emulating Lighted Decorations,” which was filed on May 8, 2008, the disclosure of which is hereby incorporated entirely herein by reference.

### BACKGROUND

1. Technical Field

Aspects of this document relate generally to heartbeat emulating lighted decorations.

2. Background Art

Lighted decorative items, such as where a user can illuminate jewelry or other decorative items, are known in the art. Conventional lighted decorative items generally relate to devices that may be lit either with a continuous light or by lights that flash.

### SUMMARY

Aspects of this document relate to heartbeat emulating lighted devices.

In one aspect, a heartbeat emulating lighted device comprises a base layer assembly having an upper base layer comprising an upper surface and a lower base layer comprising a lower surface. A decorative item having a front surface and a rear surface is embedded in the upper base layer such that at least the rear surface of the decorative item is below the upper surface of the base layer. A control circuit and light source are coupled with the base layer assembly, and the control circuit and light source are capable of illuminating the base layer assembly and outputting a first light pulse output and a second light pulse output different from the first light pulse output. The first light pulse output comprises a first ascending voltage slope having a first ascending voltage duration and a first descending voltage slope having a first descending voltage duration, the first ascending voltage slope substantially equal to the first descending voltage slope and the first ascending voltage duration substantially equal to the first descending voltage duration. Also, the second light pulse output comprises a second ascending voltage slope having a second ascending voltage duration and a second descending voltage slope having a second descending voltage duration, the second descending voltage slope being substantially less steep than the second ascending voltage slope and the second descending voltage duration being substantially longer than the second ascending voltage duration.

Particular implementations may include one or more of the following. The upper base layer may comprise a transparent material. The lower base layer may comprise a translucent material. The control circuit may further comprise at least one vertical support, and the control circuit and light source are embedded in the lower base layer such that at least a portion of the control circuit and light source are located below the lower surface of the lower base layer. The rear surface of the decorative item may be supported by the at least one vertical support of the control circuit.

In another aspect, a heartbeat emulating lighted device includes a base layer having an upper surface and a lower surface and a decorative item having a front surface and a rear surface. The rear surface of the decorative item in communication with the base layer. A control circuit and light source are coupled with the base layer and the control circuit and light source are capable of illuminating the base layer and outputting a first light pulse output and a second light pulse output, such that a systole and a diastole of a human heartbeat is visually represented.

Particular implementations may include one or more of the following. The base layer may comprise one of a transparent material and a translucent material. The rear surface of the decorative item may be in contact with and substantially coextensive with the upper surface of the base layer. The decorative item may be embedded in the base layer such that at least the rear surface of the decorative item is located below the upper surface of the base layer. The rear surface of the decorative item may be located above the upper surface of the base layer. The base layer may comprise at least an upper base layer having the upper surface and a lower base layer having the lower surface. The upper base layer may comprise a transparent material. The lower base layer may comprise a translucent material. The first light pulse output and the second light pulse output may be substantially equal. The first light pulse output may be substantially different than the second light pulse output. The first light pulse output may comprise a first ascending voltage slope having a first ascending voltage duration and a first descending voltage slope having a first descending voltage duration, the first ascending voltage slope substantially equal to the first descending voltage slope and the first ascending voltage duration substantially equal to the first descending voltage duration, and the second light pulse output may comprise a second ascending voltage slope having a second ascending voltage duration and a second descending voltage slope having a second descending voltage duration, the second descending voltage slope being substantially less steep than the second ascending voltage slope and the second descending voltage duration being substantially longer than the second ascending voltage duration.

In still another aspect, a heartbeat emulating lighted device comprises a base layer having an upper surface and a lower surface, and a control circuit and light source coupled with the base layer. The control circuit and light source are capable of illuminating the base layer and outputting a first light pulse output and a second light pulse output such that a systole and a diastole of a human heartbeat is visually represented.

Particular implementations may include one or more of the following. The base layer may comprise one of a transparent and a translucent material. A decorative item may be provided, the decorative item having a front surface and a rear surface, the rear surface of the decorative item in communication with the base layer. The first light pulse output may comprise a first ascending voltage slope having a first ascending voltage duration and a first descending voltage slope having a first descending voltage duration, the first ascending voltage slope substantially equal to the first descending voltage slope and the first ascending voltage duration substantially equal to the first descending voltage duration, and the second light pulse output may comprise a second ascending voltage slope having a second ascending voltage duration and a second descending voltage slope having a second descending voltage duration, the second descending voltage slope being substantially less steep than the second ascending voltage slope and the second descending voltage duration being substantially longer than the second ascending voltage duration.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations of heartbeat emulating lighted devices will hereinafter be described in conjunction with the appended drawings, where like designations denote like elements, and where:

FIG. 1 illustrates a perspective assembled view of a first particular implementation of a heartbeat emulating lighted device;

FIG. 2 illustrates a cross-sectional view taken along cross sectional line 2-2 in FIG. 1;

FIG. 3 illustrates a graphical illustration of a first particular implementation of a waveform;

FIG. 4 illustrates a first particular implementation of a circuit diagram;

FIG. 5 illustrates a perspective assembled view of a second particular implementation of a heartbeat emulating lighted device; and

FIG. 6 illustrates a cross-sectional view taken along cross sectional line 6-6 in FIG. 5.

### DESCRIPTION

This disclosure, its aspects and implementations, are not limited to the specific components or assembly procedures disclosed herein. Many additional components and assembly procedures known in the art consistent with the intended operation of a heartbeat emulating lighted device and/or assembly procedures for a heartbeat emulating lighted device will become apparent from this disclosure. Accordingly, for example, although particular heartbeat emulating lighted devices, base layer assemblies, base layers, upper base layers, lower base layers, decorative items, control circuits, power sources, switches, first light pulse outputs, second light pulse outputs, first ascending voltage slopes, first descending voltage slopes, first ascending voltage durations, first descending voltage durations, second ascending voltage slopes, second descending voltage slopes, second ascending voltage durations, second descending voltage durations, transparent materials, translucent materials, vertical supports, astable multivibrators, integrated circuit inverters, control transistors, resistors, current-limiting resistors, capacitors, diodes, backing plates, and attachment mechanisms are disclosed, such heartbeat emulating lighted devices, base layer assemblies, base layers, upper base layers, lower base layers, decorative items, control circuits, power sources, switches, first light pulse outputs, second light pulse outputs, first ascending voltage slopes, first descending voltage slopes, first ascending voltage durations, first descending voltage durations, second ascending voltage slopes, second descending voltage slopes, second ascending voltage durations, second descending voltage durations, transparent materials, translucent materials, vertical supports, astable multivibrators, integrated circuit inverters, control transistors, resistors, current-limiting resistors, capacitors, diodes, backing plates, attachment mechanisms, and implementing components may comprise any shape, size, style, type, model, version, measurement, concentration, material, quantity, and/or the like as is known in the art for such heartbeat emulating lighted devices, consistent with the intended operation of a heartbeat emulating lighted device.

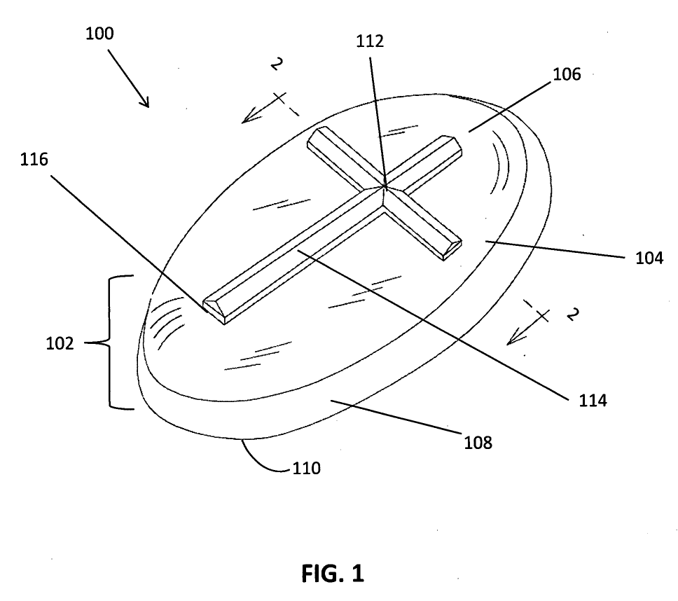

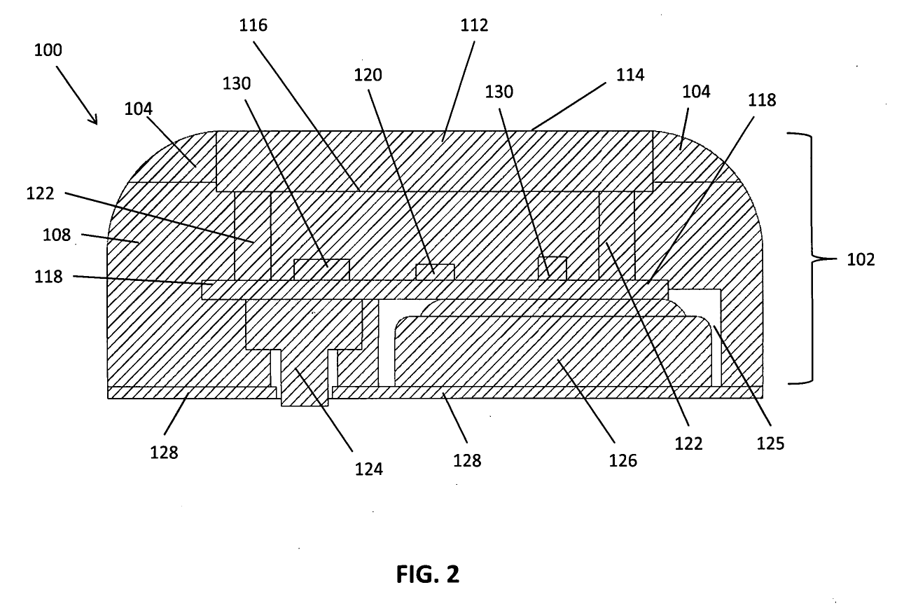

There are a variety of heartbeat emulating lighted device implementations disclosed herein and made possible with this disclosure. The various implementations of heartbeat emulating lighted devices disclosed and made possible herein relate generally to various ways to provide an imitation of a human heartbeat with sequentially timed and controlled pulses of light. FIGS. 1-2 illustrate a first particular implementation of a heartbeat emulating lighted device 100, which involves at least embedding (or otherwise providing communication between) a decorative item and a base layer, which may be back-lit by a light source. Specifically, the first particular implementation of heartbeat emulating lighted device 100 includes a base layer assembly 102, which has an upper base layer 104 (comprising an upper surface 106) and a lower base layer 108 (comprising a lower surface 110). In some particular implementations, the upper base layer 104 and the lower base layer 108 are each made of a transparent material such as, by way of non-limiting example, epoxy, polyurethane, or polyester resin, a transparent gemstone such as emerald, or any other natural or man-made material that allows light to pass therethrough without significant diffusion. In other particular implementations, the upper base layer 104 and the lower base layer 108 are each made of a translucent material such as, by way of non-limiting example, frosted glass, jade, turquoise, or any other natural or man-made material that allows light to pass therethrough diffusely. In still other particular implementations, such as the one shown with respect to FIGS. 1-2, the upper base layer 104 comprises a transparent material and the lower base layer 108 comprises a translucent material. In yet other particular implementations, the upper base layer 104 and the lower base layer 108 may (one or the other individually, or both) be formed of a combination or a mixture of transparent and/or translucent (and/or opaque) materials.

In some particular implementations, a decorative item 112 comprising a front surface 114 and a rear surface 116 is in communication with the upper base layer by being embedded in the upper base layer 104 (or simply embedded in a base layer in those particular implementations not having an upper base layer and a lower base layer, as described further below) such that at least the rear surface 116 of the decorative item 112 is located below the upper surface 106 of the upper base layer 104. In other particular implementations, a decorative item 112 may be in communication with the upper base layer by being completely embedded in the upper base layer 104 such that even the front surface 114 of the decorative item is located beneath the upper surface 106 of the upper base layer 104. In still other particular implementations, a decorative item 112 may be in communication with the upper base layer by being coupled with the upper base layer 104 such that the rear surface 116 of the decorative item is in contact with and substantially coextensive with the upper surface 106 of the upper base layer 104. In yet other particular implementations, a decorative item 112 may be in communication with the upper base layer by being coupled with the upper base layer 104 such that the rear surface 116 of the decorative item is located substantially above the upper surface 106 of the upper base layer 104 (in such particular implementations, mounting hardware or other attachment features may be used to couple the decorative item 112 with the upper base layer or the base layer, according to the particular implementation).

A decorative item 112 may comprise any solid, semi-solid and/or filigree form and may be formed of any transparent material, and/or translucent material, and/or opaque material (such as, by way of non-limiting example, precious metals, opaque gemstones, opaque plastics, or any other natural or man-made material that significantly blocks the passage of light therethrough). A decorative item 112 may comprise any Religious or secular symbol, word, design, geometric shape, number, logo, slogan, sports team or product indicia, or any other decoration or design element.

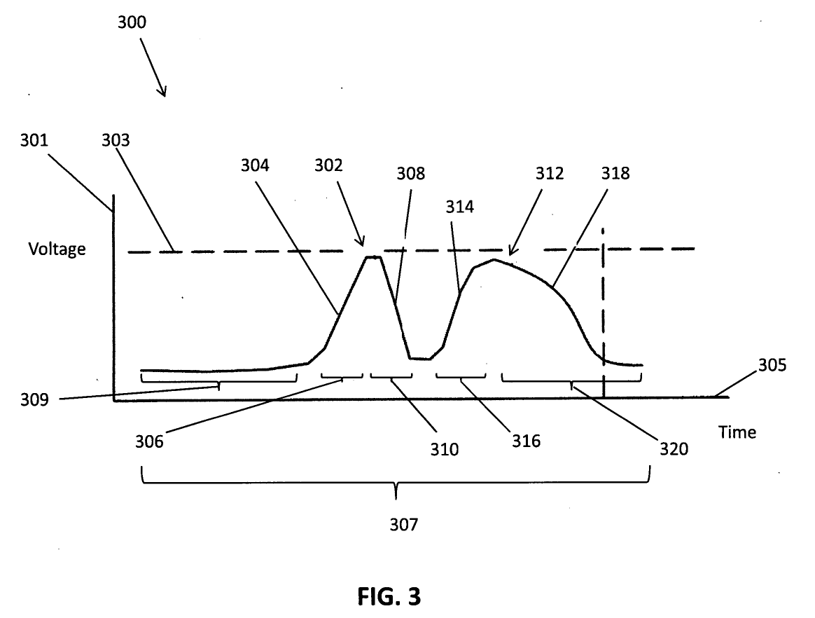

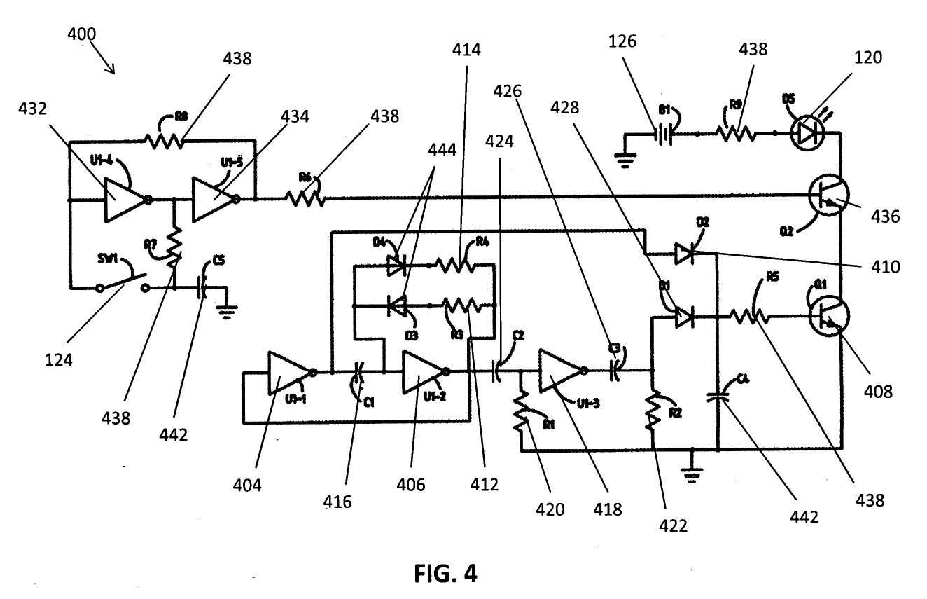

Turning now to the cross-sectional view illustrated with respect to FIG. 2, this figure shows a control circuit 118, a light source 120, a vertical support 122, an activation switch 124, a power source 126, a backing plate 128, and additional electrical components 130 (shown and described further with respect to FIG. 4, below). The control circuit 118 is described further with respect to FIG. 3 below. The light source 120 may comprise any light-emitting diode (LED), incandescent lamp, or any other light-emitting bulb or lamp known in the art, and may be powered by a power source 126 via a current limiting resistor, as described further below with respect to FIG. 4. In some particular implementations, a distance between a light source 120 and a decorative item 112 may be about 0.05 inches to 0.15 inches, in order to provide maximum light distribution on the decorative item 112. Nevertheless, other distances, consistent with the requirements and specifications of a particular implementation, may be used. In any event, a power source 126 may comprise any AC power source, DC power source, solar power source, mechanical power source, spring-loaded power source, self-winding or motion-winding power source, thermal body-heat power source, or any other power source known in the art.

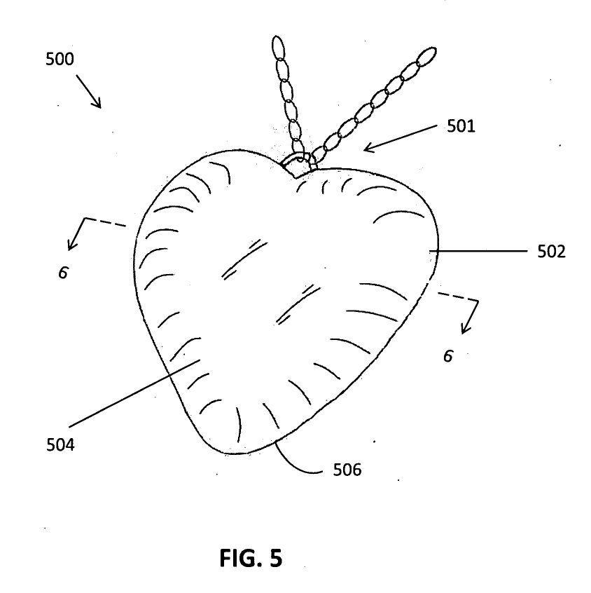

The light source 120 is mounted on the control circuit 118. The control circuit 118 is in electrical communication with the activation switch 124, the power source 126, and additional electrical components 130. In some particular implementations, such as the one illustrated in FIG. 2, the control circuit 118 and light source 120 are embedded in the lower base layer 108 such that at least a portion of the control circuit 118 and the light source 120 are located below the lower surface of the lower base layer 108 (or beneath the lower surface of a base layer, such as lower surface 506 in FIG. 5, in those particular implementations not having both an upper base layer and a lower base layer). In the particular implementation shown, the control circuit 118 and light source 120 are embedded entirely within the lower base layer 108, along with the power source 126, although they may be partially embedded, or even located entirely outside of the lower base layer 108.

In addition, the activation switch 124 may be partially or entirely located within the lower base layer 108. In the particular implementation shown, a backing plate 128 (which may be formed of any transparent, translucent, opaque, conductive, and/or insulative material) is used to provide a substantially flush lower surface 110 (with or without the control circuit 118 and light source 120 located beneath). In the particular implementation shown, the activation switch 124 protrudes through the backing plate 128, although in other particular implementations, the activation switch 124 may include any automatic switch, motion detecting switch, sound-detecting switch, body-temperature detecting switch, photo-electric switch, timed switch, biorhythmic switch, or any other mechanical, electrical or chemical switch and may be located above or beneath the backing plate 128 and may be activated via a pinhole and/or any other mechanical, electrical, chemical, and/or protected activation arrangement known in the art.

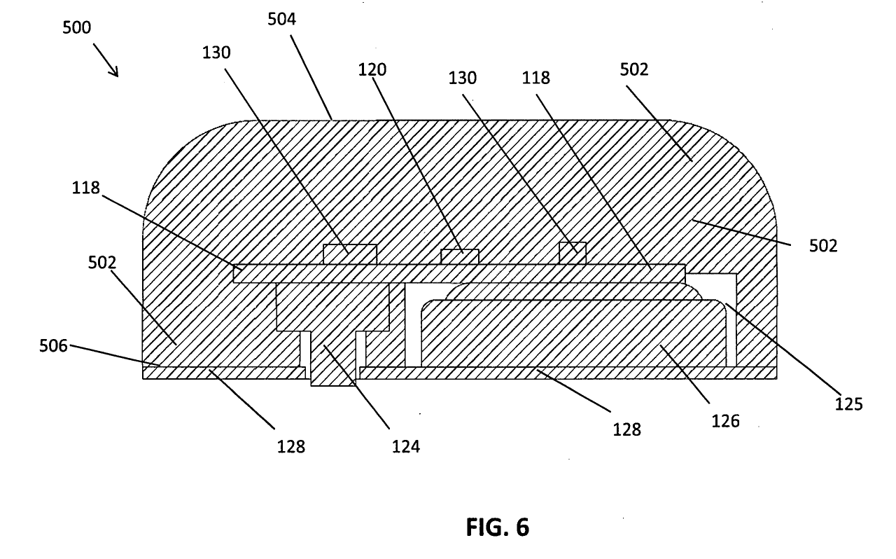

Still referring to FIG. 2, one or more vertical supports 122 extend from the control circuit 118 and support the rear surface 116 of the decorative item 112. In those particular implementations that do not include one or more decorative items 112, such as the one illustrated with respect to FIGS. 5-6, the one or more vertical supports 122 may not be provided. In any event, the control circuit 118 and the light source 120 are capable of illuminating the base layer assembly 102 (or the base layer, in those particular implementations not having an upper base layer and a lower base layer, such the particular implementation illustrated with respect to FIGS. 5-6). Specifically, the control circuit 118 is configured to control the light source 120 in order to provide an output (or more than one output) according to pre-determined controls. As described further below with respect to FIG. 3, and depending upon the particular implementation used, one or more pre-determined controls may be set to closely simulate a human heartbeat at various rates, and/or may be programmed to output a rough representation of a human heartbeat at various rates. In any event, it will be understood that the particular characteristics of how the base layer assembly 102 is illuminated may relate at least to the composition of the upper base layer 104 and the lower base layer 108, respectively. By way of non-limiting example, different lighting characteristic may be achieved at least depending on a thickness of one or both of the upper base layer 104 and the lower base layer 108, and/or whether one or both of the upper base layer 104 and the lower base layer 108 are formed of transparent, as opposed to translucent and/or opaque materials (and/or any combination thereof).

Turning now to FIG. 3, a non-limiting example of first light pulse output 302 and a second light pulse output 312 waveform are illustrated. Of course, various waveforms, representing numerous and various human heartbeat possibilities, may be used in accordance with the disclosures contained herein. For example, a waveform may attempt to closely mimic a human heartbeat waveform with light (such as the non-limiting example provided in FIG. 3) and may therefore be suitable for medical purposes, or other applications where realism is desired and/or required. By contrast, a waveform may not attempt to closely “scientifically” duplicate the pattern of a human heartbeat with light, but may merely evoke or emulate a human heartbeat for aesthetic, calming, or other purposes. In any event, the control circuit 118 and the light source 120 together are capable of illuminating the base layer assembly 102 (and/or a decorative item 112, if provided) by outputting a first light pulse output 302 and a second light pulse output 312 (or any other light pulse output or outputs), which may be programmed to take on pre-determined waveforms and may repeated at various programmable, random or pre-determined intervals. Specifically, in the particular implementation shown, a voltage provided to the light source 120 begins at or about 0 volts and the light source 120 remains unactivated during quiescent duration 309 (which represents a significant portion of compete cycle duration 307, and which may therefore aid in resisting the depletion of the power source 126). A first light pulse output 302 occurs after the quiescent duration 309. Specifically, the first light pulse output 302 has a first ascending voltage slope 304 having a first ascending voltage duration 306, and a first descending voltage slope 308 having a first descending voltage duration 310. Significantly, in this particular implementation, the first ascending voltage slope 304 is substantially equal to the first descending voltage slope 308 and the first ascending voltage duration 306 is substantially equal to the first descending voltage duration 310. Notwithstanding, in other particular implementations one more inequalities may be present with respect to the first ascending voltage slope 304 in relation to the first descending voltage slope 308 and/or with respect to the first ascending voltage duration 306 in relation to the first descending voltage duration 310.

FIG. 3 further illustrates a non-limiting example of a second light pulse output 312. Specifically, in the particular implementation shown, the second light pulse output 312 has a second ascending voltage slope 314 having a second ascending voltage duration 316, and a second descending voltage slope 318 having a second descending voltage duration 320. Significantly, in this particular implementation, the second ascending voltage slope 304 is substantially steeper than the second descending voltage slope 318 and the second descending voltage duration 320 is substantially longer than the second ascending voltage duration 316. Notwithstanding, in other particular implementations the second ascending voltage slope 314 may be substantially equal to the second descending voltage slope 318 and/or the second descending voltage duration 320 may be substantially equal to the second ascending voltage duration 316. While the particular implementation illustrated and described with respect to FIG. 3 illustrates one non-limiting example of a first light pulse output 302 and a second light pulse output 312, it will be understood that, depending upon the particular implementation, the first light pulse output 302 and/or the a second light pulse output 312 may be substantially equal (e.g. equalities exist between ascending slope and descending slope and/or between ascending slope duration and descending slope duration). In other particular implementations, the first light pulse output 302 may be substantially different than the second light pulse output 312 (e.g. one or more inequalities may exist between ascending slope and descending slope and/or between ascending slope duration and descending slope duration). Also, depending upon the particular implementation, one or more pre-determined controls associated with control circuit 118 may be set to closely simulate a human heartbeat at various rates, and/or may be programmed to output a rough representation of a human heartbeat at various rates. By way of non-limiting example, various medical applications might require a more realistic representation of a human heartbeat to be programmed in control circuit 118 (such as that illustrated in FIG. 3), whereas certain educational, aesthetic, or novelty applications to FIG. 3, may only require to be programmed to output a rough representation of a human heartbeat.

Still referring to FIG. 3, y-axis 301 represents a voltage, where maximum voltage 303 represents approximately 2-3 volts, in this particular implementation. Notwithstanding, in other particular implementations, another maximum voltage may be used, depending upon the requirements of a particular application, the needs of a particular user, and/or the requirements of a particular light source 120 and/or a particular power source 126. In addition, x-axis 305 represents a time, where complete cycle duration 307 represents a range from approximately 1/20 of a minute to about 1/300 of a minute. In addition, quiescent duration 309 may represent a range from approximately 1/300 of a minute to approximately 1/20 of a minute. It will be understood that a complete cycle duration 307 may be repeated as many times, and at whatever intervals, as desired.

Referring now to FIG. 4, a non-limiting example of an electrical schematic 400, that may be used with respect to any particular implementation of a heartbeat emulating lighted device, is illustrated. In the particular implementation illustrated, the first light pulse output 302 (FIG. 3) is formed by an astable multivibrator which is formed by integrated circuit inverter 404 (U1-1) and integrated circuit inverter 406 (U1-2). The first light pulse output 302 proceeds to control transistor 408 (Q1) through diode 410 (D2). It will be understood that the timing of first light pulse output 302 and its associated waveform (whether as shown with respect to FIG. 3, or any other waveform disclosed or made possible herein) may be determined by the values of resistor 412 (R3), resistor 414 (R4), and/or capacitor 416 (C1) which, in particular implementations, may equal approximately 2 mega-ohms, 100 kilo-ohms and 0.1 microfarad, respectively.

The second light pulse output 312 (FIG. 3) is created by a delayed pulse generator which may be formed by inverter 418 (U1-3) and its associated circuitry. The specific timing and waveform (whether as shown with respect to FIG. 3, or any other waveform) of second light pulse output 312 may be controlled by resistor 420 (R1), resistor 422 (R2), capacitor 424 (C2), and/or a capacitor 426 (C3) which, in particular implementations, may equal approximately 1.5 mega-ohms, 100 kilo-ohms, 0.1 microfarads, and 0.1 microfarads, respectively. The second light pulse output 312 proceeds to control transistor 408 (Q1) via diode 428 (D1). The light source 120 (FIG. 2) may comprise any light-emitting diode (LED) or other known light source and may be powered by power source 126 (B1) via a current limiting resistor which, in particular implementations, may range from approximately 0-1.0 ohms. Additional inverter circuit 432 (U1-4) and inverter circuit 434 (U1-5) may be provided in order to cause switch 124 (SW1) to trigger a “push on-push off” circuit via one or more of the inverter circuits. It will be understood that a “push on-push off” circuit may control transistor 436 (Q2), which may allow or disallow current to flow through the light source 120 (D5). In addition, one or more additional resistors 438 (e.g., R5-R9), one or more additional capacitors 442 (e.g. C4 & C5), and/or one or more additional diodes 444 (e.g., D3 & D4) may be provided according to the specific configuration and/or requirements of a particular implementation. It will be understood that, while one particular non-limiting example of an electrical schematic 400 is illustrated, numerous configurations of numerous various electronic components could and can be used to create an emulated human heartbeat pattern according to the disclosures contained herein.

Still referring to FIG. 4, it will be understood that the additional electrical components 130 described with respect to FIG. 2 and FIG. 6 may comprise any of the electrical components shown in FIG. 4 (or other electrical components known in the art) such as, by way of non-limiting example: one or more astable multivibrators; one or more integrated circuit inverters; one or more control transistors; one or more diodes; one or more resistors; one or more capacitors; one or more delayed pulse generators; one or more inverters; one or more power sources; one or more current limiting resistors; one or more inverter circuits; one or more switches; one or more “push on-push off” circuits; one or more light sources; one or more additional resistors; one or more additional capacitors; and/or one or more additional diodes, including any circuitry associated with any of the foregoing components.

Turning now to FIGS. 5-6, a second particular implementation of a heartbeat emulating lighted device 500 is illustrated. Heartbeat emulating lighted device 500 comprises an attachment mechanism 501 which may comprise any clasp, fastener, hook, eyelet, chain, snap, pin, biased clip, or other attachment mechanism known in the art. Significantly, while an attachment mechanism is not specifically shown with respect to the first particular implementation of heartbeat emulating lighted device 100 (illustrated with respect to FIGS. 1-2), it will nevertheless be understood that any attachment mechanism known in the art may be provided. Turning back to FIG. 5, a heartbeat emulating lighted device 500 includes a single base layer 502 (as opposed to an upper base layer and a lower base layer), which has an upper surface 504 and a lower surface 506. In this second particular implementation, a control circuit 118 and light source 120 illuminate the base layer 502 (and one or more decorative items, when provided). As with the first particular implementation, the control circuit 118 and light source 120 may be embedded with respect to the base layer 502 such that the control circuit 118 and/or the light source 120 are located entirely or partially beneath the lower surface 506 of the base layer 502. As with the first particular implementation, in the second particular implementation of heartbeat emulating lighted device 500, the control circuit 118 and the light source 120 together are capable of illuminating the base layer 502 by outputting a first light pulse output 302 and a second light pulse output 312 (FIG. 3) which, as described above, may be programmed to take on pre-determined waveforms and may repeated at various programmable, random or pre-determined intervals. As shown specifically in FIG. 5, the base layer 502 may comprise a decorative shape such as, by way of non limiting example, a heart-shape, any religious or secular symbol, word, design, geometric shape, number, logo, slogan, sports team or product indicia, or any other decoration or design element. The base layer 502 may comprise any transparent or translucent material, or combination thereof. In addition, in some particular implementations, the base layer 502 may comprise one or more opaque portions.

A comparison of FIG. 6 (second particular implementation of heartbeat emulating lighted device 500) to FIG. 2 (first particular implementation, heartbeat emulating lighted device 100) illustrates that the heartbeat emulating lighted device 500 has a single base layer 502 (as opposed to heartbeat emulating lighted device 100, FIG. 2, which has at least an upper base layer 104 and a lower base layer 108). In addition, FIG. 6 illustrates that heartbeat emulating lighted device 500 does not necessarily include a decorative item 112. Notwithstanding, in some particular implementations of heartbeat emulating lighted device having a single base layer (such as heartbeat emulating lighted device 500), one or more decorative items 112 may be provided in accordance with the disclosures contained herein. It will be understood that where no decorative item 112 is provided, that one or more vertical supports 122 (FIG. 2) may not be included, as illustrated in FIG. 6.

It will be understood by those of ordinary skill in the art that the concepts of using base layers, control circuits, and light sources to provide a heartbeat emulating lighted device is not limited to heartbeat emulating lighted devices or to the specific implementations shown or described herein. For example, it is specifically contemplated that the components included in a particular implementation of a heartbeat emulating lighted device may be formed of any of many different types of materials or combinations that can readily be formed into shaped objects and that are consistent with the intended operation of a heartbeat emulating lighted device. For example, the components may be formed of: polymers and/or other like materials; plastics and/or other like materials; resins (natural and/or synthetic); gemstones (natural and/or synthetic), glasses (natural and/or synthetic), metals and/or other like materials; precious metals; alloys; composites and/or other like materials; and/or any combination of the foregoing.

Furthermore, the heartbeat emulating lighted devices, base layer assemblies, base layers, upper base layers, lower base layers, decorative items, control circuits, power sources, switches, first light pulse outputs, second light pulse outputs, first ascending voltage slopes, first descending voltage slopes, first ascending voltage durations, first descending voltage durations, second ascending voltage slopes, second descending voltage slopes, second ascending voltage durations, second descending voltage durations, transparent materials, translucent materials, vertical supports, astable multivibrators, integrated circuit inverters, control transistors, resistors, current-limiting resistors, capacitors, diodes, backing plates, attachment mechanisms and any other components forming a particular implementation of a heartbeat emulating lighted device may be manufactured separately and then assembled together, or any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

It will be understood that particular implementations are not limited to the specific components disclosed herein, as virtually any components consistent with the intended operation of a method and/or system implementation for a heartbeat emulating lighted device may be utilized. Accordingly, for example, although particular base layers, control circuits, light sources, additional electrical components, and implementing components may be disclosed, such components may comprise any shape, size, style, type, model, version, class, grade, measurement, concentration, material, weight, quantity, and/or the like consistent with the intended operation of a method and/or system implementation for a heartbeat emulating lighted device may be used.

In places where the description above refers to particular implementations of a heartbeat emulating lighted device, it should be readily apparent that a number of modifications may be made without departing from the spirit thereof and that these implementations may be applied to other heartbeat emulating lighted devices. The accompanying claims are intended to cover such modifications as would fall within the true spirit and scope of the disclosure set forth in this document. The presently disclosed implementations are, therefore, to be considered in all respects as illustrative and not restrictive, the scope of the disclosure being indicated by the appended claims rather than the foregoing description. All changes that come within the meaning of and range of equivalency of the claims are intended to be embraced therein.

What is claimed is:

1. A heartbeat emulating lighted device comprising:
a base layer assembly having an upper base layer comprising an upper surface and a lower base layer comprising a lower surface;
a decorative item having a front surface and a rear surface, the decorative item embedded in the upper base layer such that at least the rear surface of the decorative item is below the upper surface of the base layer;
a control circuit and light source coupled with the base layer assembly, the control circuit and light source capable of illuminating the base layer assembly and outputting a first light pulse output and a second light pulse output different from the first light pulse output;
wherein the first light pulse output comprises a first ascending voltage slope having a first ascending voltage duration and a first descending voltage slope having a first descending voltage duration, the first ascending voltage slope substantially equal to the first descending voltage slope and the first ascending voltage duration substantially equal to the first descending voltage duration; and
wherein the second light pulse output comprises a second ascending voltage slope having a second ascending voltage duration and a second descending voltage slope having a second descending voltage duration, the second descending voltage slope being substantially less steep than the second ascending voltage slope and the second descending voltage duration being substantially longer than the second ascending voltage duration.

2. The device of claim 1, wherein the upper base layer comprises a transparent material.

3. The device of claim 1, wherein the lower base layer comprises a translucent material.

4. The device of claim 1, wherein the control circuit further comprises at least one vertical support, and wherein the control circuit and light source are embedded in the lower base layer such that at least a portion of the control circuit and light source are located below the lower surface of the lower base layer.

5. The device of claim 4, wherein the rear surface of the decorative item is supported by the at least one vertical support of the control circuit.

6. A heartbeat emulating lighted device comprising:
a base layer having an upper surface and a lower surface;
a decorative item having a front surface and a rear surface, the rear surface of the decorative item in communication with the base layer; and
a control circuit and light source coupled with the base layer, the control circuit and light source capable of illuminating the base layer and outputting a first light pulse output and a second light pulse output such that a systole and a diastole of a human heartbeat is visually represented.

7. The device of claim 6, wherein the base layer comprises one of a transparent material and a translucent material.

8. The device of claim 6, wherein the rear surface of the decorative item is in contact with and substantially coextensive with the upper surface of the base layer.

9. The device of claim 6, wherein the decorative item is embedded in the base layer such that at least the rear surface of the decorative item is located below the upper surface of the base layer.

10. The device of claim 6, wherein the rear surface of the decorative item is located above the upper surface of the base layer.

11. The device of claim 6, wherein the base layer comprises at least an upper base layer having the upper surface and a lower base layer having the lower surface.

12. The device of claim 11, wherein the upper base layer comprises a transparent material.

13. The device of claim 11, wherein the lower base layer comprises a translucent material.

14. The device of claim 6, wherein the first light pulse output and the second light pulse output are substantially equal.

15. The device of claim 6, where the first light pulse output is substantially different than the second light pulse output.

16. The device of claim 6, wherein:
the first light pulse output comprises a first ascending voltage slope having a first ascending voltage duration and a first descending voltage slope having a first descending voltage duration, the first ascending voltage slope substantially equal to the first descending voltage slope and the first ascending voltage duration substantially equal to the first descending voltage duration; and
wherein the second light pulse output comprises a second ascending voltage slope having a second ascending voltage duration and a second descending voltage slope having a second descending voltage duration, the second descending voltage slope being substantially less steep than the second ascending voltage slope and the second descending voltage duration being substantially longer than the second ascending voltage duration.

17. A heartbeat emulating lighted device comprising:
a base layer having an upper surface and a lower surface; and
a control circuit and light source coupled with the base layer, the control circuit and light source capable of illuminating the base layer and outputting a first light pulse output and a second light pulse output, such that a systole and a diastole of a human heartbeat is visually represented.

18. The device of claim 17, wherein the base layer comprises one of a transparent and a translucent material.

19. The device of claim 18, further comprising a decorative item having a front surface and a rear surface, the rear surface of the decorative item in communication with the base layer.

20. The device of claim 17, wherein:
the first light pulse output comprises a first ascending voltage slope having a first ascending voltage duration and a first descending voltage slope having a first descending voltage duration, the first ascending voltage slope substantially equal to the first descending voltage slope and the first ascending voltage duration substantially equal to the first descending voltage duration; and
wherein the second light pulse output comprises a second ascending voltage slope having a second ascending voltage duration and a second descending voltage slope having a second descending voltage duration, the second descending voltage slope being substantially less steep than the second ascending voltage slope and the second descending voltage duration being substantially longer than the second ascending voltage duration.
